(19) United States
(12) Patent Application Publication
(10) Pub. No.: US 2010/0295299 A1
(43) Pub. Date: Nov. 25, 2010

(54) JOINT AND JOINING METHOD FOR PLASTIC PIPE

(75) Inventor: Christopher G. Ziu, Lenexa, KS (US)

Correspondence Address: EDWARDS ANGELL PALMER & DODGE LLP, P.O. BOX 55874, BOSTON, MA, 02205, US

(73) Assignee: ORION ENTERPRISES, INC., Kansas City, KS (US)

(21) Appl. No.: 12/602,035

(22) PCT Filed: Jun. 12, 2008
(86) PCT No.: PCT/US08/07371

§ 371 Date: Aug. 2, 2010

Related U.S. Application Data
(60) Provisional application No. 60/943,333, filed on Jun. 12, 2007.

(51) Int. Cl. F16L 23/00; H05B 6/10

(52) U.S. Cl. 285/416; 219/643

(57) ABSTRACT

A coupling for joining socket ends of multilayer tubing through electrofusion including a central body having opposing male ends. A core at least partially surrounds the central body and an outer layer encloses the core and central body. The outer layer defines a flange protruding radially outwardly from the central body, wherein the core includes a portion that extends radially outwardly through the flange and out of the flange so that the core can be directly heated by an external heating element.

### TECHNICAL FIELD OF THE DISCLOSURE

The present disclosure relates to a joint and a joining method for multilayer composite tubing having at least one middle layer of malleable metal. The joint and joining method prevent the middle metal layer from being exposed to liquid flow within coupled tubes so that the tubes can meet stringent sanitary requirements.

### BACKGROUND OF THE DISCLOSURE

Potable water piping is one of the highest volume piping products sold worldwide. It is an essential part of virtually all forms of construction, and particularly where there is human occupancy. Traditional materials for conveying potable water in smaller diameters include copper, steel, and plastic pipe and tubing. Within the last fifteen to twenty years cross-linked polyethylene (PEX) tubing has gained popularity because PEX tubing can be delivered in coiled bundles and because PEX tubing can handle most cold and hot water distribution system applications. As the price of copper has risen, use of PEX tubing has steadily increased in residential and commercial applications.

In the 1990s, flexible multilayer composite tubing was introduced which includes an inner layer of thermoplastic material (such as polyethylene (PE), polypropylene (PP) or PEX), a malleable metallic layer such as welded aluminum or copper, and an outer layer such as PE, PEX or PP. The inner and outer layers are typically bonded to the aluminum by means of an adhesive layer to result in a gas tight construction, reducing permeation. Such an assembly results in tubing which can be made with thin layers for economy, yet has reasonably high pressure ratings compared to even thicker straight thermoplastic tubing due to the metallic layer, even at elevated temperatures. The flexible multilayer tubing can be deliverable in coiled bundles, yet permanent bends can be field-formed on the tubing.

The multilayer composite tubing solves many of the problems previously associated with tubing made from other materials. This includes the high capital costs expense associated with straight copper tubing and chlorinated polyvinyl chloride (CPVC) tubing, the expense of making a multitude of joints in solvent weld PVC and CPVC systems, and the difficulty in bending PEX and Polybutylene tubing and preventing kinking and twisting in the tubing.

Joints currently used with multilayer composite tubing comprise a brass joint that is crimped onto ends of the tubing. The brass joint crimping method, however, reduces the flow in tubing by up to 60% and, in addition, since the price of brass is directly related to the price of copper, the price of brass joints has also risen. The brass joint crimping method, therefore, removes some of the otherwise considerable price advantages of PEX and composite multiplayer tubing over copper tubing.

An alternative to crimped brass joints is the TOTAL™ joint system recently introduced by Industrias Saladillo S. A. (see U.S. patent application Ser. No. 11/388,366, filed on 24 Mar. 2006). The TOTAL™ system includes flaring the end of multilayer composite tubing into a female socket, inserting a molded thermoplastic cap into the female end to seal the metal layer, and inserting the cap into a fitting socket using a traditional hand-held heating element socket fusion method.

Traditional heat element socket fusion is a method that is popular outside the U.S. but not popular in the U.S. since contractors in the U.S. tend to view this method as being cumbersome and difficult to teach to laborers installing plumbing materials. For this reason, the benefits offered by Industrias Saladillo's TOTAL™ system (i.e., all thermoplastic fittings, no reduction in diameter or flow, etc.) will probably not be realized in the U.S. In addition, the thermoplastic couplings and fittings of the TOTAL™ system have a reduced strength compared to the rest of the multilayer tubing, which is a disadvantage in high temperature tubing applications, high pressure applications such as compressed air lines, and process piping applications.

What is still desired is a new and improved joint and method for joining multiplayer composite tubing having at least one middle layer of malleable metal. The joint and joining method will preferably prevent the middle metal layer from being exposed to liquid flow within coupled tubes. In addition the joining method can preferably be easily conducted in the field during installation of the tubing without the use of a heating element socket fusion tool. Furthermore, the resulting joint will preferably be as strong as the connected tubing.

### SUMMARY OF THE DISCLOSURE

It has been recognized by this inventor that multilayer thermoplastic tubing would serve as an ideal basis for hot and cold potable water piping systems, as well as for radiant heating, compressed air and chemical process piping. The inner layer can be extruded using a higher temperature rated thermoplastic such as PEX, PP or even a flexible copolymer form of PVDF (a copolymer created from momoners of vinylidene fluoride and hexafluoropropylene, sometimes referred to as Kynar Flex®, which is a trade name of Arkema, Inc.), materials which are already readily accepted into water and compressed air applications, as well as chemical process piping applications.

The outer layer can be offered as a pigmented product with special additives such as UV inhibitors to protect against UV attack of the pipe (a problem inherent in PP materials without additives), since the outer layer is not a wetted component. Dissimilar systems such as PVDF-Aluminum-PP combinations can even be offered where PVDF is needed for the wetted contact layer, such as in a process piping application involving concentrated sulfuric acid (greater than 98% acid concentration), and PP can be used as the outer layer to reduce the price of the tubing and fittings. Such a system could be delivered into a project in long coils (e.g., 100 meter coils) and rolled out into seamless and jointless straight lengths. Further, a certain number of consecutive bends can be field-formed using forming and bending tools, and flexible inserts.

Advantageously, when using the multilayer composite tubing as the base for a cost effective water, air, or process piping system, the tubing ends can be field-formed into female sockets, as described for example in U.S. patent application Ser. No. 11/388,366 (since the malleable metallic substrate is formable in this fashion) and then joined using mating male parts of similar multilayer construction by means of direct or indirectly applied heat, induction heating or modified electrofusion. This would allow the metallic substrate to be completely isolated from the wetted fluid, while offering a proven, readily accepted joint and joining method. The use of malleable metals such as aluminum or copper serve a dual purpose in this instance in that they are formable, have better strength than straight thermoplastic materials, yet also are excellent conductors of heat and would thereby assist in the transmitting of heat between the male spigots and formed female sockets, yet would also resist thermal swelling of the plastic layers, resulting in strong welded joints.

The use of a flared socket into the tubing end that is mated to a male spigoted coupling or fitting capable of being heated by indirect application of heat or electrofusion is a novel and non-obvious method that solves many of the problems previously associated with such joints in straight thermoplastic rigid or flexible tubing, and in multilayer tubes. The joints can be easily and readily made by means of a very simple process, using simple battery powered tools. Further, the joining system can be accomplished in a variety of configurations and even in the tightest and most difficult of areas, such as where the tubes are routed in wooden framing, ceiling spaces, and behind ducting.

The couplings and fittings disclosed herein, although novel and non-obvious, are all easily and readily manufactured using such mass production techniques such as simple forming tools for the metallic parts (in the case of a part which uses a solid mass of material) and injection molding for the thermoplastic encapsulation. In addition, off-the-shelf elbows with a variety of radii and a multitude of bend angles can be shop manufactured using cut sections of the extruded tubing by forming belled sockets into the ends of the elbow fittings. This will significantly reduce the number of molded components that will need to be supplied by the manufacturer for the limited number of times an actual elbow is required. Compound angles, offsets, and expansion loops can also be pre-manufactured, incorporating bends in multiple planes that can be offered as off-the-shelf components. Certain other fittings such as reductions in diameter can also be formed using shop fixtures to create concentric and eccentric reductions in diameters, again thereby further lessening the number of components needed to offer a complete piping system.

It is apparent that this combination of system with its many novel features offers a system with unparalleled advantages over previous potable water, air, and process piping systems. The use of coiled tubes in long lengths that can be rolled out in rigid fashion, together with the field formability of many of the elbows in the system means that the system will be able to have 70 to 90 percent of the joints in the system eliminated. There is simply no more cost effective welded or bonded thermoplastic joint that can be achieved than by means of an electrofusion or induction welding type joint. Further, the use of materials which are perfectly suited to water, air and process chemical transport as the inner, wetted layer together with materials that have protection against outside effects such as ultraviolet light attack solves problems that have been previously encountered in a very unique way.

Where expensive materials such as PVDF or PFA are required as the wetted material in a process application, combinations of materials can be used with a less expensive outer layer for the tubing, thereby providing a much more economical combination of materials than would otherwise be required, especially when considering that the inner layer itself can be made thin since the malleable metallic layer provides the mechanical strength. Fittings for this kind of combination material system may be constructed with the thermoplastic encapsulation consisting completely of the same material as the inner layer.

In addition, the incorporation of electrofusion or induction welding style joints (e.g., joints heated by indirect application of heat) into the limited number of joints that are required provide for an accepted method that would result in very strong connections. Since this type of joining method can be accomplished by readily and cost effectively building the means to facilitate it directly into the couplings and fittings. The resulting combination system yields an effective water, air, and process piping system.

In one embodiment, the subject technology is directed to a coupling for joining socket ends of multilayer tubing through electrofusion including a central body having opposing male ends. A core at least partially surrounds the central body and an outer layer encloses the core and central body. The outer layer defines a flange protruding radially outwardly from the central body, wherein the core includes a portion that extends radially outwardly through the flange and out of the flange so that the core can be directly heated by an external heating element.

In another embodiment, the subject technology is directed to a coupling system for joining socket ends of multilayer tubing. The coupling system has a coupling having: a central body having opposing male ends; a core at least partially surrounding the central body; and an outer layer that encloses the core and central body, the outer layer defining a flange protruding radially outwardly from the central body. The core includes a portion that extends radially outwardly into the flange to facilitate heating of the flange. Further, the core may have a Curie temperature that is slightly above a melting temperature range of a plastic outer layer of the joining socket ends, whereby the core then becomes paramagnetic, and essentially switches off when heated to the Curie temperature. A collar element may surround the outer layer for providing energy to the core.

The subject technology is also a method for joining a socket end of multilayer tubing to a coupling comprising the steps of: inserting the coupling at least partially in the socket end; selectively providing an external electrical coil around an exterior of the socket end such that the electrical coil selectively creates an electric field within the coupling; providing a ferromagnetic core within the coupling such that when the electric field is present, a temperature of the ferromagnetic core elevates sufficiently to fuse the socket end to the coupling.

Another method of making a coupling for joining socket ends of multilayer tubing includes the steps of: providing an inner tube; surrounding the inner tube with a ferromagnetic core; and winding and consolidating unidirectionally extruded thermoplastic tape about the ferromagnetic core. The ferromagnetic core may extend into a flange.

Another coupling in accordance with the subject technology includes a central body having opposing male ends, a core at least partially surrounding the central body, and an outer layer that encloses the core and central body, the outer layer defining a flange protruding radially outwardly from the central body. The core includes a portion that extends radially outwardly through the flange and out of the flange so that the core can be directly heated by an external heating element.

In another embodiment, the subject technology is a method for joining socket ends to multilayer tubing including the steps of: selectively clamping an external heating element around an exterior of the socket ends such that the heating element contacts an exposed portion of a central core of the socket ends; heating the core to a temperature that is at or above a melting temperature of an outer layer enclosing the core so that the outer layer can be melted and fused to thermoplastic layers of the multilayer tubing; and applying heat and external pressure to the socket ends of the multilayer tubing and the coupling.

A coupling may also be a central body having opposing male ends, a core at least partially surrounding the central body, wherein the core includes a substrate layer affixed with a flexible heating element and an outer layer that encloses the core and central body. Alternatively, the coupling may include a central body having opposing ends, a core at least partially surrounding the central body, wherein the core includes a sleeve and an electrical resistance wire wound around a carrier sleeve and an outer layer that encloses the core and central body.

Additional aspects and advantages of the present disclosure will become readily apparent to those skilled in this art from the following detailed description, wherein only exemplary embodiments of the present disclosure are shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF DRAWINGS

Reference is made to the attached drawings, wherein elements having the same reference character designations represent like elements throughout, and wherein:

FIG. 1 is a sectional view of an exemplary embodiment of a coupling constructed in accordance with the present disclosure and including an inner core of high thermal conductivity material having an exposed external portion;

FIG. 2 is an end perspective view of the coupling of FIG. 1;

FIG. 3 is a sectional view of the coupling of FIG. 1 shown inserted into the belled socket ends of multilayer composite tubes, with an external heating element positioned over the belled socket ends to apply heat directly to the exposed external portion of the inner core of high thermal conductivity material within the coupling;

FIG. 4 is a sectional view of another exemplary embodiment of a coupling constructed in accordance with the present disclosure and including a fully encapsulated inner core of ferromagnetic material;

FIG. 5 is an end perspective view of the coupling of FIG. 4;

FIG. 6 is a sectional view of the coupling of FIG. 4 shown inserted into the belled socket ends of multilayer tubes, with an external electrical coil positioned over the belled socket ends to apply indirect induction heating to the coupling;

FIG. 7 is a sectional view of still another exemplary embodiment of a coupling constructed in accordance with the present disclosure and including a fully encapsulated inner core of ferromagnetic material;

FIG. 8 is an end perspective view of the coupling of FIG. 7;

FIG. 9 is a sectional view of yet another exemplary embodiment of a coupling constructed in accordance with the present disclosure and including a fully encapsulated inner core of high thermal conductivity material, a heating element in contact with the conductive layer, and external terminal connectors electrically connected to the heating element through lead wires;

FIG. 10 is an elevation end view, partially in section, of the coupling of FIG. 9;

FIG. 11 is an end perspective view of the coupling of FIG. 9;

FIG. 12 is a sectional view of a further exemplary embodiment of a coupling constructed in accordance with the present disclosure and including an electrical resistance wire wound around a carrier sleeve pre-form so that that the wire is directed towards a radial outward exterior of the coupling and fusion can occur from the inside out, and external terminal connectors electrically connected to ends of the resistance wire;

FIG. 13 is a sectional view of the electrical resistance wire and carrier sleeve pre-form of the coupling of FIG. 12;

FIG. 14 is a perspective view of an exemplary embodiment of an elbow coupling constructed in accordance with the present disclosure;

FIG. 15 is a perspective view of an exemplary embodiment of a tee coupling constructed in accordance with the present disclosure; and

FIG. 16 is a perspective view of an exemplary embodiment of a transition coupling constructed in accordance with the present disclosure.

### DETAILED DESCRIPTION OF EXEMPLARY EMBODIMENTS

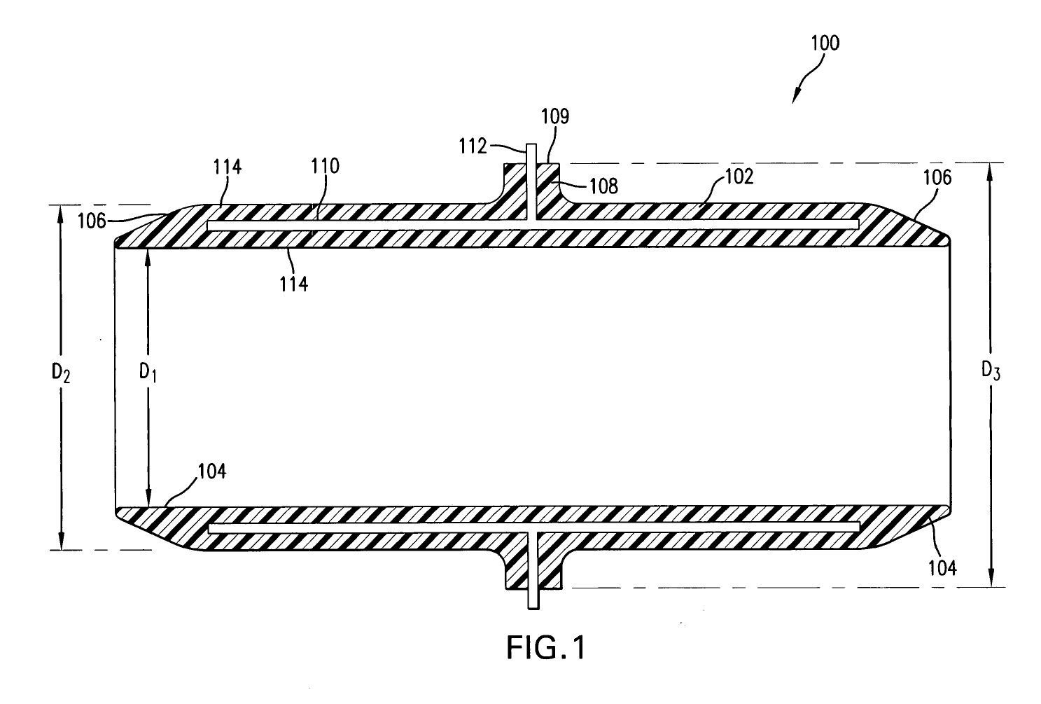

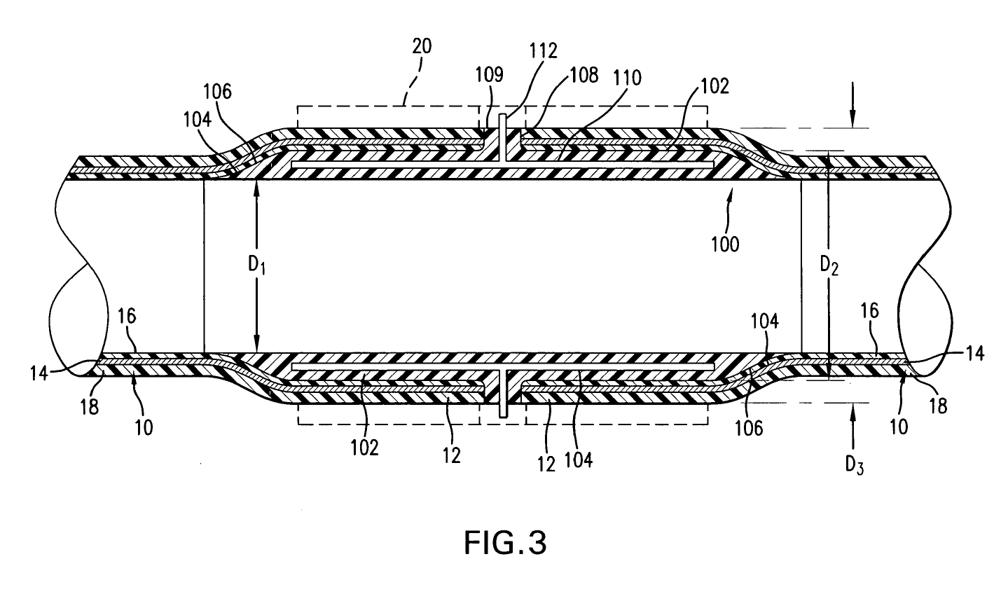

Referring now to the detailed drawings, FIGS. 1-3 show an exemplary embodiment of a tubular coupling 100 constructed in accordance with the present disclosure. As shown in FIG. 3, the coupling 100 is adapted to join belled socket ends 12 of multilayer tubing 10 through electrofusion and is especially intended for use with multilayer composite tubing having at least one middle layer of malleable metal 14, such as aluminum, and inner and outer layers of plastic 16, 18, such as cross-linked polyethylene (PEX).

The coupling 100 includes a central body 102 having an inside diameter D1 and an outside diameter D2 and opposing male ends 104 (commonly referred to as “spigots” or “spigot ends”). In the exemplary embodiment shown, the spigot ends 104 are provided with tapered outer surfaces 106, which are adapted to match a tapered inner surface formed into the belled socket ends 12 of the tubing 10.

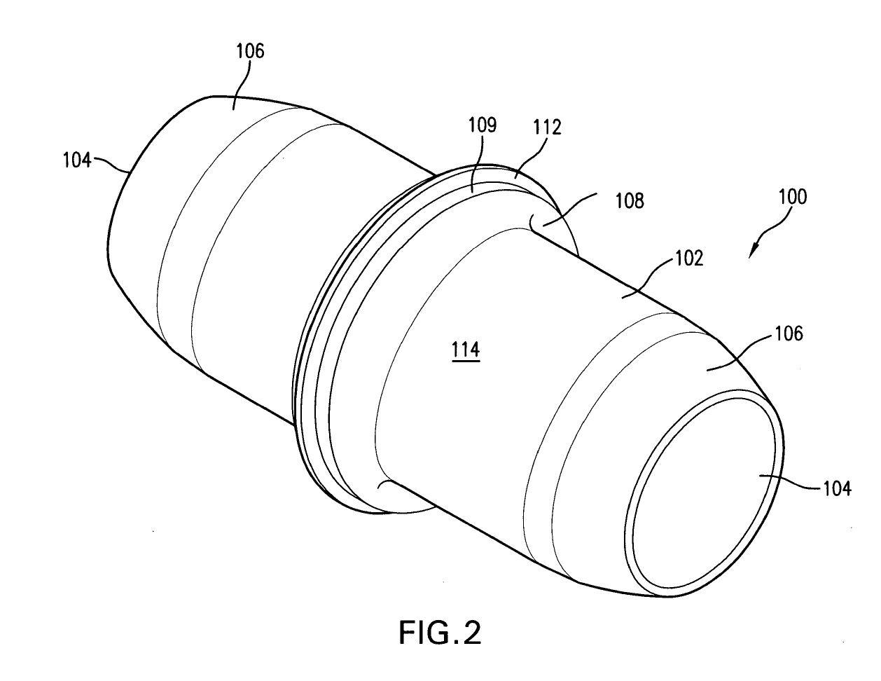

The coupling 100 also includes a flange 108, which protrudes radially outwardly from the central body 102 and has a radial outer surface 109. In the exemplary embodiment shown, the flange 108 is centrally located between the opposing male ends 104. The flange 108 can extend throughout the entire 360° of the circumference of the coupling 100, i.e., be continuous as shown best in FIG. 2, or only extend from a portion of the circumference. In either embodiment, the flange 108 extends radially out to a diameter D3, which preferably matches an outside diameter of the belled socket ends 12 of the multilayer tubing 10 to which the coupling 100 is to be joined.

Still referring to FIGS. 1-3, the coupling 100 includes a core 110 and an outer thermoplastic layer 114 that encloses the core 110. The core 110 provides reinforcement and is comprised of a material that is of higher strength than the surrounding outer thermoplastic layer 114. The core 110, for example, comprises metal, glass, or reinforced thermoplastic material. The material of the core 110 also has a relatively high thermal conductivity and a low heat capacity so that, when heated via conduction, the heat is conducted efficiently throughout the core 110 and transferred readily to the surrounding outer layer 114. During a thermal fusion procedure, the core 110 is heated to a temperature that is at, or somewhat above, the melting temperature of the thermoplastic outer layer 114 so that the thermoplastic material of the outer layer 114 can be melted and fused to the thermoplastic layers 16, 18 of the multilayer tubing 10.

In the exemplary embodiment of FIGS. 1-3, the core 110 is itself tubular and extends coaxially with the body 102 of the coupling 100. The core 110 includes a portion 112 that extends radially outwardly from the core through the flange 108 and out of the radial outer surface 109 of the flange 108 so that the core 110 can be directly heated by an external heating element or heating clamp, as well as heated indirectly by conduction. As shown in FIG. 3, an external heating element 20 can be clamped around the exterior of the belled socket ends 12 of the multilayer tubing 10 such that the heating element 20 contacts the exposed portion 112 of the central core 110, while also applying heat and some external pressure to the belled socket ends 12 of the multilayer tubing 10 and the coupling 100.

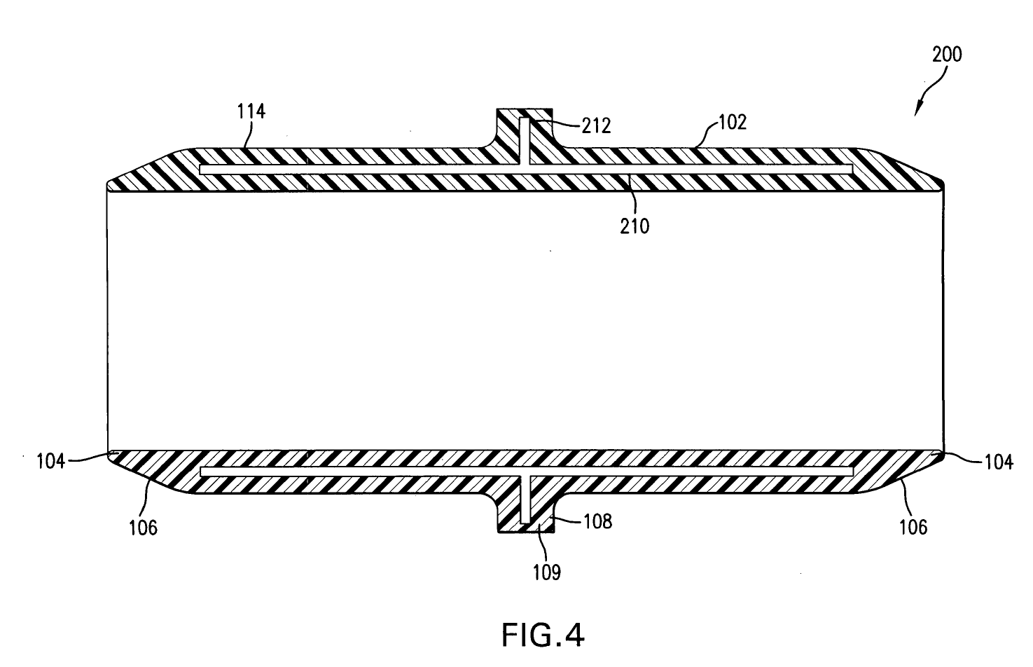

FIGS. 4-6 show another exemplary embodiment of a coupling 200 constructed in accordance with the present disclosure. The coupling 200 of FIGS. 4-6 is similar to the coupling 100 of FIGS. 1-3 such that similar elements are labeled with the same reference characters. In the embodiment 200 of FIGS. 4-6, however, a core 210 of the coupling 200 is provided with a radially extending portion 212 that extends into the flange 108 but does not extend out of the radial outer surface 109 of the flange 108.

The core 210 in this embodiment 200 is comprised of material that is magnetically permeable, i.e., ferromagnetic, so that the core can be heated by induction heating. Without being limited to any particular theory, induction heating uses an externally positioned electrical coil. To create heat by induction heating, current is circulated around an internally positioned ferromagnetic material, usually with the current being circulated at a very high frequency. The circulating current creates a magnetic field and, in turn, the ferromagnetic particles align in the ferromagnetic material. As a result, the ferromagnetic material turns into a magnet while the current is applied, and also creates heat due to the friction between the molecules.

The material comprising the core 220 may also have a Curie temperature that is slightly above the melting temperature range of the plastic outer layer 114, whereby the core 210 then becomes paramagnetic, and essentially switches itself off when it is heated to the Curie temperature. This feature might be beneficial in preventing the plastic material 114 from becoming overheated and degraded, which could damage the plastic and result in a defective joint.

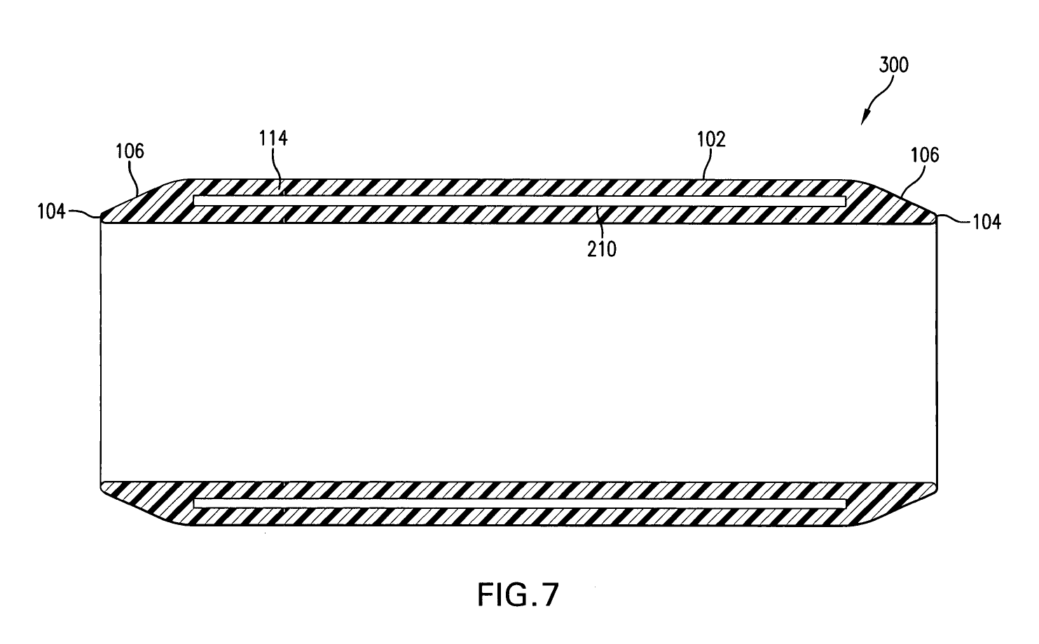

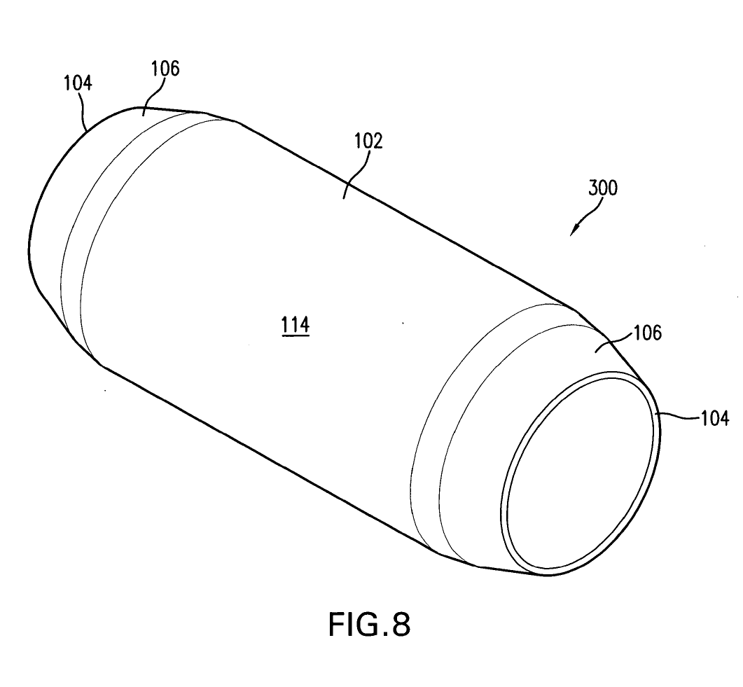

Examples of ferromagnetic materials for the core 210 include carbon steel, iron, carbon, and carbon-reinforced thermoplastic materials. The carbon reinforced thermoplastic version might comprise a central tube material that is manufactured by winding and consolidating unidirectionally extruded thermoplastic tape (e.g., polypropylene, polyethylene, PVDF, etc.) that is reinforced with unidirectional carbon fibers extruded into the tape. Such construction would make the core 210 not only susceptible to being heated by induction heating from an external source, but it would also be exceptionally strong, i.e. stronger than even that of a solid metallic material, yet lightweight. The core 210 may or may not have a radially extending portion, as is illustrated in the embodiment 300 of FIGS. 7-8. In the exemplary embodiment of FIGS. 7-8, the coupling 300 also does not have a flange. Alternatively, the coupling 300 could have a flange extending from the body 102, but no radially extending portion from the core 210 extending into the flange.

Rather than heating the central core 210 of the couplings 200, 300 of FIGS. 4-8 by means of induction heating, the core 210 can be externally heated by simply using an external clamped band-type heater with the couplings 200, 300. Heat would be induced directly to the exterior surfaces of the belled sockets 12 of the multilayer tubing 10 by the externally clamped band-type heater. Heat would then be conducted across the various layers of the sockets 12, and eventually to the couplings 200, 300 to result in fusion. If this method is used, the central core 210 would not have to be magnetically permeable, but would preferably have a high thermal conductivity and low heat capacity to aid in the conductive heat transfer process.

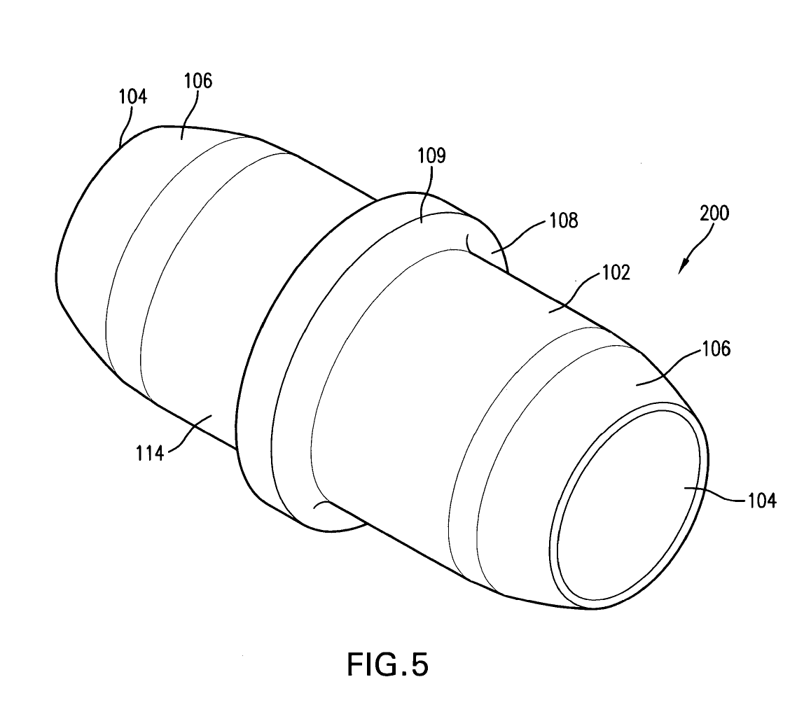

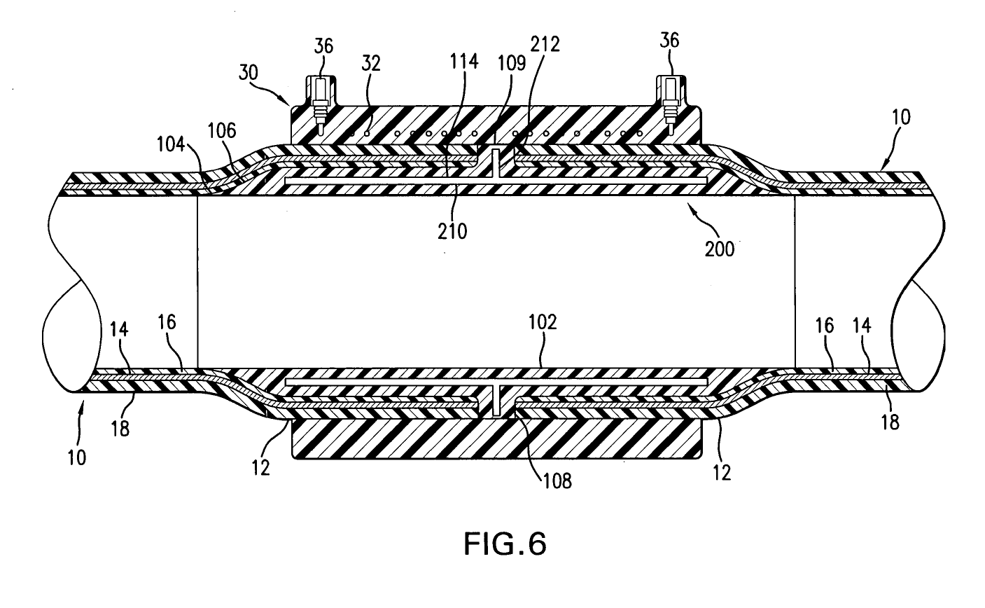

In FIG. 6, an external induction heating coil 32 in the form of a standard female electrofusion coupling 30 is shown surrounding the assembly of the coupling 200 of FIGS. 4-5 and the socket ends 12 of the multilayer tubing 10. The female coupling 30 has terminal pins 36 connected to wires 34 of the heating coil 32. Instead of a coupling 30, the external induction coil 32 could alternatively be provided as part of a clamped sleeve or external wand. In this illustration, the male interior coupling 200 and the female electrofusion coupling 30 are shown as two distinct pieces and are separated along the interface 109. However, in another possible embodiment the male coupling 200 and the female coupling 30 are made in a unitary fashion, whereby the radial flange 108 is an interconnecting member between the couplings 200, 30, and the interface 109 is nonexistent.

Such a unitary part could be made by first creating a pre-form, such as those described in U.S. Pat. Nos. 6,258,197 and 4,885,574. The pre-form is then fitted with wires 34 and connector pins 36 and loaded into a second injection mold, whereby the rest of the part is molded, including the inner core 210 which is also insert molded into the secondary step injection mold. In such a coupling concept, weld between the outer female coupling 30 and the multilayer tubes 10 is not critical and as such the clearances between the multilayer tube socket ends 12 and the coupling 30 do not have to be as tight. It is a further bonus though if the interior surface and the exterior surface of the socket end 12 of the multilayer tube 10 are both welded to thermoplastic material, which makes an exceptionally strong assembly where the central malleable layer 14 of the tube 10 is thoroughly protected and sealed. Alternatively, the female coupling 30 could provide a resistive wire 32 as a heating element to provide heat to the core 210.

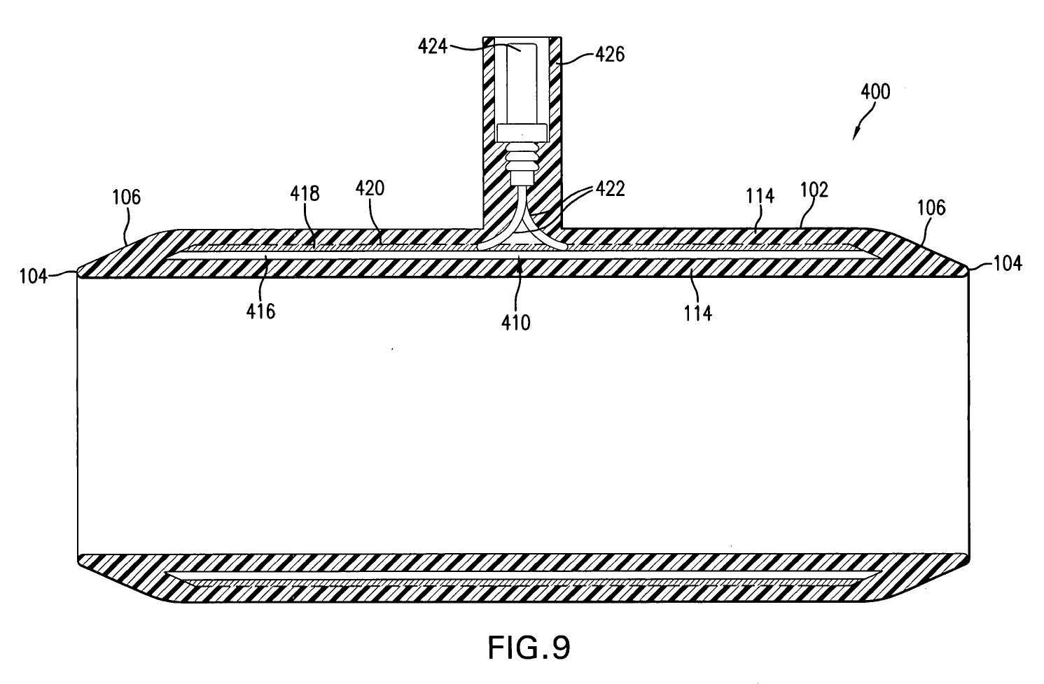

FIGS. 9-11 show another exemplary embodiment of a coupling 400 constructed in accordance with the present disclosure. The coupling 400 of FIGS. 9-11 is similar to the coupling 100 of FIGS. 1-3 such that similar elements are labeled with the same reference characters. The coupling 400, however, includes a core 410 comprising a substrate layer 416 affixed with a flexible heating element 418, such as a Kapton® Polyimide or silicon heating element that can be produced by etching with an electrical resistance circuit 420 by the photoresist method. The flexible heating element 418 should be of a material and construction such that it can reach and maintain a maximum temperature higher than the melting range of the thermoplastic material of the outer layer 114 for which it is intended to heat. The heating circuit 420 can be applied by the photoresist method using any one of a number of common resistance materials including nickel, hastelloy, aluminum alloys, and similar conductive materials. Alternatively, the circuit 420 can be manufactured using wires that are placed by hand into the heating element 418. The flexible heating element 418 is affixed with a high temperature adhesive backing so that the flexible heating element 418 can be directly adhered to the substrate 416 during the manufacturing process, and prior to the core 410 being placed in a mold for having the outer thermoplastic layer 114 over-molded over the core 410.

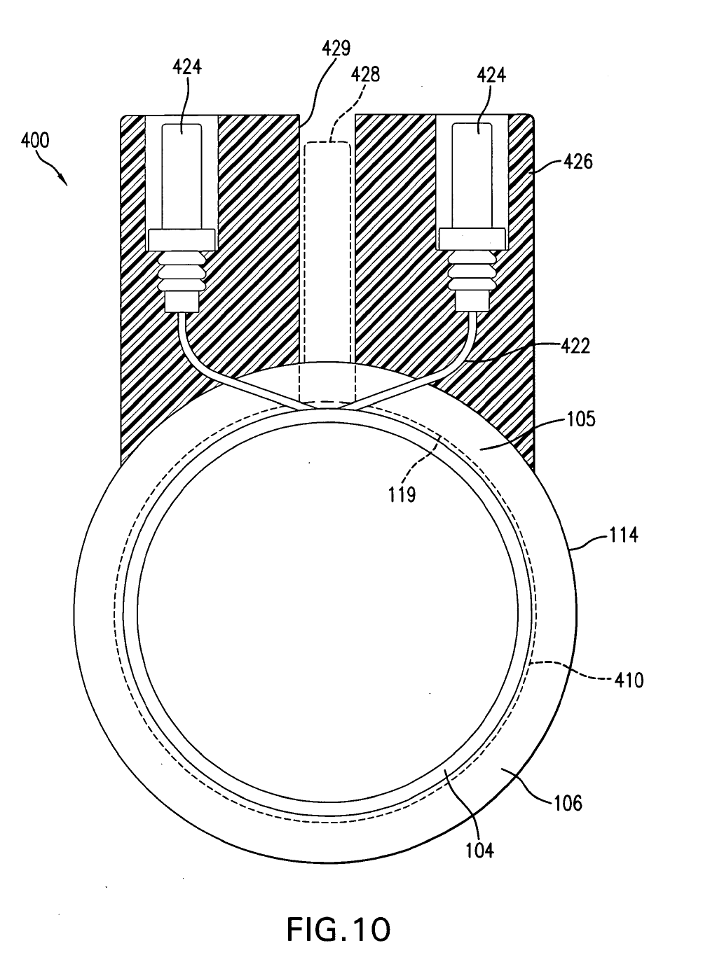

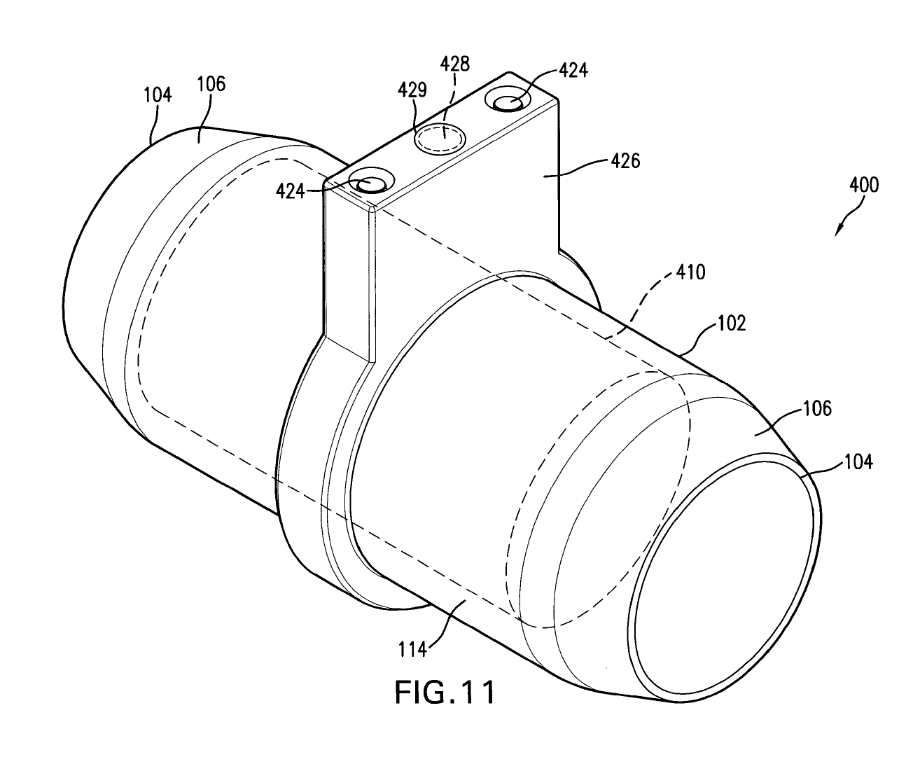

Lead wires 422 extend from the heating element 418 and are affixed to terminal pin connectors 424, which in the finished coupling 400 will be used to connect the heating element to a voltage source such as an electrofusion processor. In the exemplary embodiment shown, the terminal pin connectors 424 have an outer protective sleeve 426 molded around the connectors. As shown in FIGS. 10-11, the coupling 400 can also be affixed or equipped with a channel 429 having a pop-up fusion indicator 428 such as the type described in U.S. Pat. Nos. 4,703,150 and 4,727,242. Instead of a pop-up indicator 428, the coupling 400 could have the channel 429 remain empty so that a thermistor, thermostat, or thermostatic switch can be inserted into the channel to conduct a temperature reading and provide the electrofusion processor with important feedback. The channel may extend to the surface of the heating element 418. The thermistor, thermostat, or thermostatic switch could also be built directly into the heating element 418 so that feedback information could be provided to an electrofusion processor.

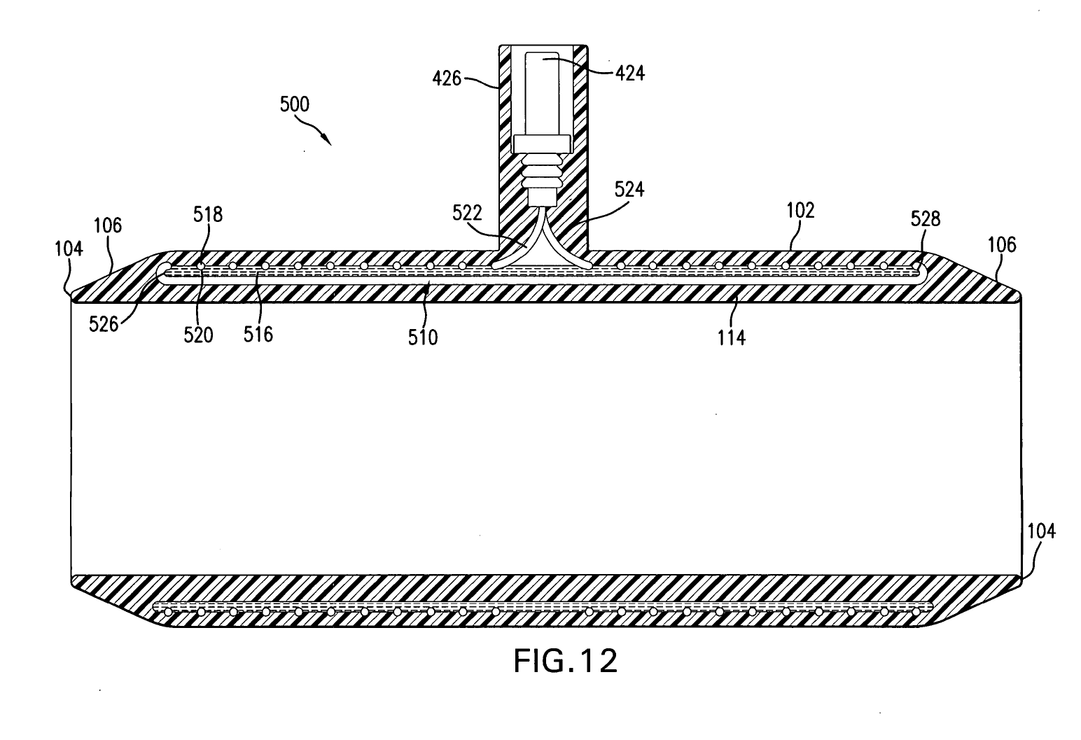

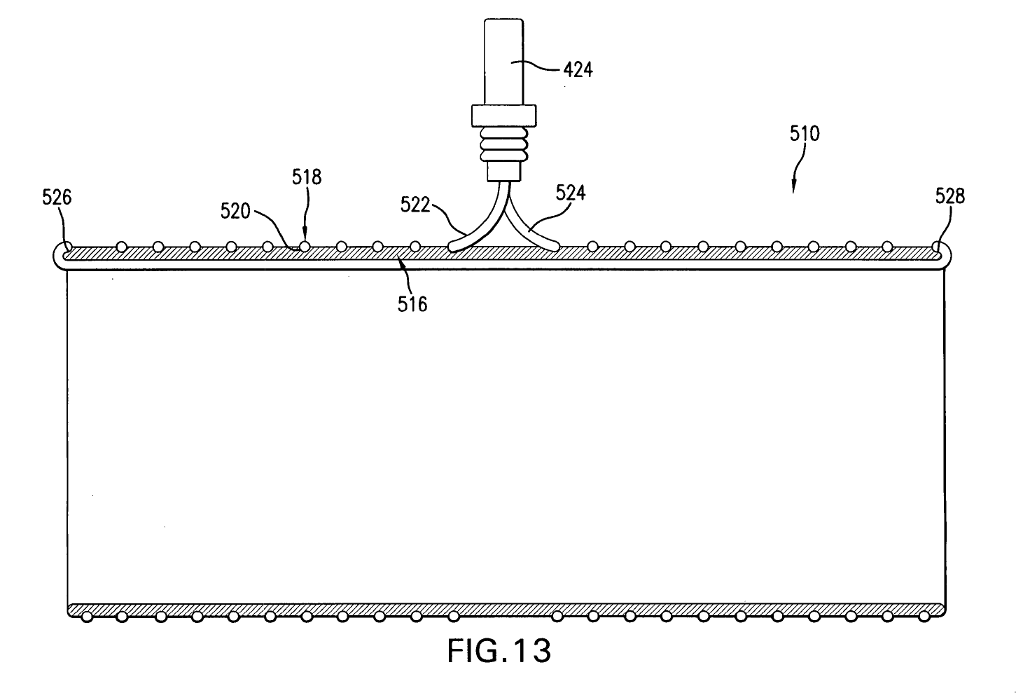

FIG. 12 shows another exemplary embodiment of a coupling 500 constructed in accordance with the present disclosure. The coupling 500 of FIG. 12 is similar to the coupling 100 of FIGS. 1-3 and 9-11 such that similar elements are labeled with the same reference characters. The coupling 500, however, includes a core 510 comprising electrical resistance wire 518 wound around a carrier sleeve pre-form 516. The core 510 is also shown in FIG. 13. The wire 518 is wound on an outer surface of the pre-form 516 so that fusion can occur from the inside out, i.e., on the radial outer surfaces of the coupling 500.

The pre-form 516 comprises a thermoplastic material or a reinforced thermoplastic material that is machined or thermoformed to have a groove 520 adapted to receive the wire 518. The wire 518 is installed by first feeding a first end 522 of the wire 518 axially through the tubular pre-form (an axially-oriented groove can also be provided on the inside surface of the pre-form). The first end 522 of the wire 518 is directed out of a first end 526 of the pre-form 516, while an opposing second end 524 of the wire 518 is directed out a second end 528 of the pre-form. The wire ends 522, 524 are then wound around the external circumference of the pre-form 516 into the spiral shaped groove (machine thread) 520 from both ends 526, 528 to the axial center of the pre-form. The wire ends 522, 524 are attached to two terminal pin connectors 424 housed within a protective outer sleeve 426. Although not shown, the coupling 500 can also be affixed or equipped with a pop-up fusion indicator. Once the wire ends 522, 524 are attached to the terminal pin connectors 424, the core 510 can be inserted into a second injection mold to have the remainder of the coupling 500 overmolded around the core.

It should be noted that a coupling constructed in accordance with the present disclosure could be provided in many configurations, such as an elbow coupling, a tee coupling, or a transition coupling. In all configurations, the coupling includes at least one spigot, or male, end, and a core as disclosed herein that is adapted to heat, melt, and fuse and outer surface of the spigot end.

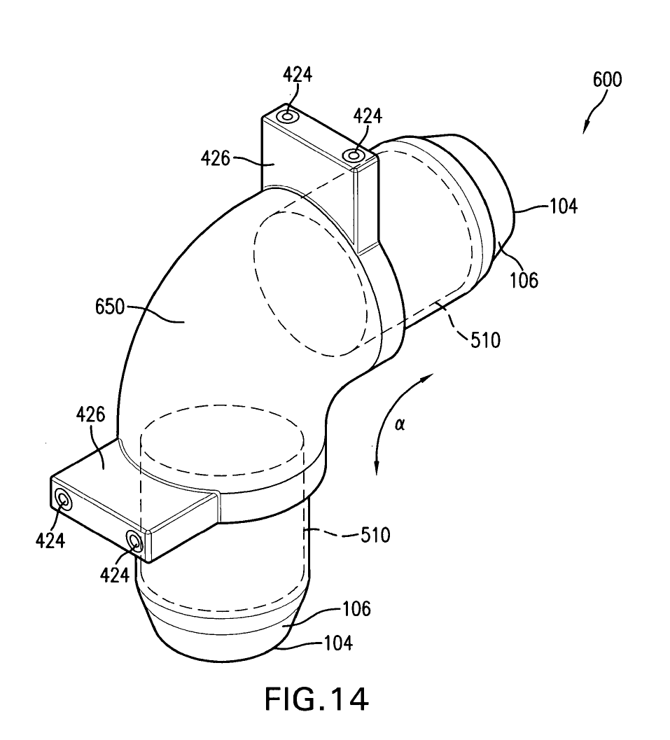

FIG. 14, for example, shows an exemplary embodiment of an elbow coupling 600 constructed in accordance with the present disclosure and that is similar to the coupling 500 of FIG. 12 such that similar elements are labeled with the same reference characters. The coupling 600 includes two spigot ends 104 connected by an elbow-shaped body 650, and cores 510 similar to the core shown in FIGS. 12-13 located in each spigot end 104. Each of the cores 510 has a set of terminal pin connectors 424. Alternatively, the coupling 600 could be adapted so that both of the cores 510 would be connected to a single set of terminal pin connectors 424. The elbow-shaped body 650 can be built to any one of a variety of angles, α, such as 30°, 45°, 60°, and 90°.

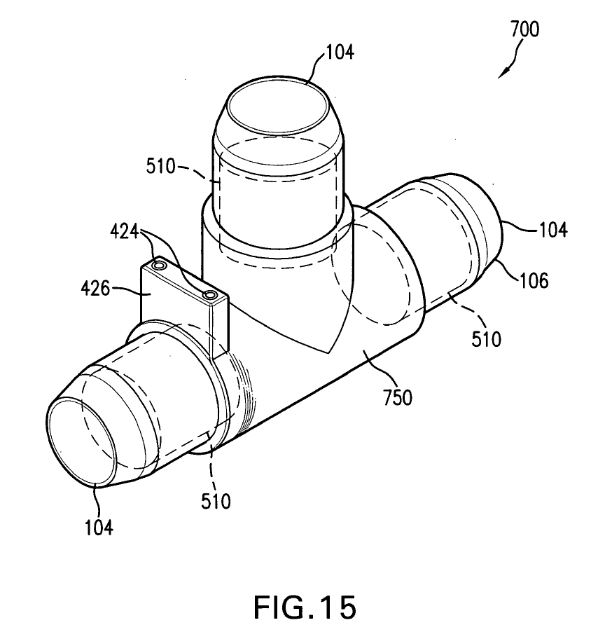

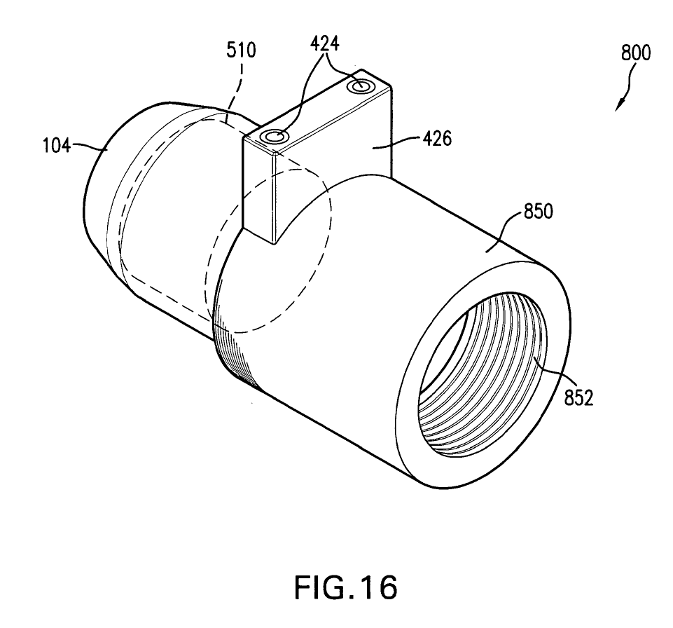

FIG. 15 shows an exemplary embodiment of a tee coupling 700 constructed in accordance with the present disclosure and that is similar to the coupling 500 of FIG. 12 such that similar elements are labeled with the same reference characters. The coupling 700 includes three spigot ends 104 connected by a T-shaped body 750, and cores 510 similar to the core shown in FIGS. 12-13 located in each spigot end 104. All of the cores 510 share a single set of terminal pin connectors 424. FIG. 16 shows an exemplary embodiment of a transition coupling 800 constructed in accordance with the present disclosure and that is similar to the coupling 500 of FIG. 12 such that similar elements are labeled with the same reference characters. The coupling 800 includes one spigot end 104 axially connected to a tubular body 850 having a threaded bore 852, and a core 510 located in the spigot end 104.

It is also envisioned that solvent cementing can also be used to permanently seal the male ends of the coupling to the socket ends of the multilayer tubing. Solvent cementing works very well with PVC, CPVC and the like, which can be used as the inner and outer layers for solvent cementing.

### Incorporation by Reference

All patents, published patent applications and other references disclosed herein are hereby expressly incorporated in their entireties by reference.

Thus, the present disclosure provides a new and improved joint and method of joining multilayer composite tubing. It is envisioned that the subject technology may be rearranged and resequenced in virtually any combination or order. It should also be understood that the exemplary embodiments described in this specification have been presented by way of illustration rather than limitation, and various modifications, combinations such as and substitutions may be effected by those skilled in the art without departure either in spirit or scope from this disclosure in its broader aspects.

1. A coupling system for joining socket ends of multilayer tubing through electrofusion comprising:
a central body having opposing male ends;
a ferromagnetic core at least partially surrounding the central body; and
an outer layer that encloses the core and central body,
wherein upon application of an electric field, the ferromagnetic core heats to weld the male ends to adjacent multilayer tubing.

2. A coupling system as recited in claim 1, wherein the core has a Curie temperature that is slightly above a melting temperature range of a plastic outer layer of the joining socket ends, whereby the core then becomes paramagnetic, and essentially switches off when heated to the Curie temperature.

3. A coupling system as recited in claim 1, further comprising a collar element surrounding the outer layer for providing energy to the core.

4. A coupling system as recited in claim 3, wherein the collar element can be removed from the outer layer.

5. A coupling system as recited in claims 3, wherein the collar element is integrally formed with the outer layer.

6. A method for joining a socket end of multilayer tubing to a coupling comprising the steps of:
inserting the coupling at least partially in the socket end;
selectively providing an external electrical coil around an exterior of the socket end such that the electrical coil selectively creates an electric field within the coupling;
providing a ferromagnetic core within the coupling such that when the electric field is present, a temperature of the ferromagnetic core elevates sufficiently to fuse the socket end to the coupling.

7. A method as recited in claim 6, further comprising the step of circulating current through the coil at a very high frequency.

8. A method of making a coupling for joining socket ends of multilayer tubing through electrofusion, the method comprising the steps of:
providing an inner tube;
surrounding the inner tube with a ferromagnetic core; and
winding and consolidating unidirectionally extruded thermoplastic tape about the ferromagnetic core.

9. A method as recited in claim 8, wherein the tape is selected from the group consisting of polypropylene, polyethylene, PVDF, combinations thereof, and the like.

10. A method as recited in claim 8, wherein the tape is reinforced with unidirectional carbon fibers extruded therein and the ferromagnetic core is selected from the group consisting of carbon steel, iron, carbon, and carbon-reinforced thermoplastic material.

11. (canceled)

12. A method as recited in any of claims 8, further comprising the step of heating the core by induction to join the socket ends.

13. A method as recited in any of claims 8, further comprising the step of forming a radially extending flange that extends into the flange.

14. (canceled)

15. A coupling for joining socket ends of multilayer tubing through electrofusion comprising:
a central body having opposing male ends;
a core at least partially surrounding the central body; and
an outer layer that encloses the core and central body, the outer layer defining a flange protruding radially outwardly from the central body, wherein the core includes a portion that extends radially outwardly through the flange and out of the flange so that the core can be directly heated by an external heating element.

16. A coupling as recited in claim 15, wherein the core provides reinforcement and has a relatively high thermal conductivity and a low heat capacity.

17. A coupling as recited in claim 15, wherein the core is tubular and extends coaxially with the body.

18. A coupling as recited in any of claims 15, wherein the outer layer is thermoplastic.

19. A coupling as recited in any of claims 15, wherein the multilayer tubing is composite having at least one middle layer of malleable metal and inner and outer layers of plastic.

20. A coupling as recited in any of claims 15, wherein the male ends form tapered outer surfaces and the socket ends are belled.

21. A coupling as recited in any of claims 15, wherein the flange has a radial outer surface substantially centrally located between the opposing male ends.

22. A coupling as recited in claim 21, wherein the radial outer surface extends radially out to a diameter, which substantially matches an outside diameter of the belled socket ends of the multilayer tubing.

23. A coupling as recited in any of claims 15, wherein the coupling is an elbow coupling.

24. A coupling as recited in any of claims 15, wherein the coupling forms an angle selected from 30°, 45°, 60°, and 90°.

25. A coupling as recited in any of claims 15, wherein the coupling is a T-shaped coupling.

26. A method for joining socket ends to multilayer tubing comprising the steps of:
selectively clamping an external heating element around an exterior of the socket ends such that the heating element contacts an exposed portion of a central core of the socket ends;
heating the core to a temperature that is at or above a melting temperature of an outer layer enclosing the core so that the outer layer can be melted and fused to thermoplastic layers of the multilayer tubing; and
applying heat and external pressure to the socket ends of the multilayer tubing and the coupling.

27. A coupling for joining socket ends of multilayer tubing through electrofusion comprising:
a central body having opposing male ends;
a core at least partially surrounding the central body, wherein the core includes a substrate layer affixed with a flexible heating element; and
an outer layer that encloses the core and central body.

28. A coupling as recited in claim 27, further comprising lead wires extending from the heating element and affixed to terminal pin connectors for connecting the heating element to a voltage source.

29. A coupling as recited in claim 27, further comprising an outer protective sleeve molded around the terminal pin connectors, the outer protective sleeve defining a channel.

30. A coupling as recited in claim 29, further comprising a pop-up fusion indicator in the channel.

31. A coupling as recited in claim 29, wherein the channel extends to the heating element.

32. A coupling for joining socket ends of multilayer tubing through electrofusion comprising:
a central body having opposing ends;
a core at least partially surrounding the central body, wherein the core includes a sleeve and an electrical resistance wire wound around a carrier sleeve; and
an outer layer that encloses the core and central body.

33. A coupling as recited in claim 32, wherein the wire is wound on an outer surface of the sleeve.

34. A coupling as recited in claim 32, wherein the sleeve defines a groove adapted to receive the wire and the opposing ends are male ends.

35. (canceled)

36. A coupling system for joining socket ends of multilayer tubing through electrofusion comprising:
a central body having opposing male ends;
a core at least partially surrounding the central body; and
an outer layer that encloses the core and central body, the outer layer defining a flange protruding radially outwardly from the central body,
wherein the core includes a portion that extends radially outwardly into the flange to facilitate heating of the flange.

37. A coupling system as recited in any of claims 36, further comprising a collar element surrounding the outer layer for heating the core and wherein the collar element is integrally formed with the outer layer.

38. (canceled)
